(19) United States
(12) Patent Application Publication
(10) Pub. No.: US 2009/0063694 A1
(43) Pub. Date: Mar. 5, 2009

(54) Multimedia Access Device, Multimedia Playing System Comprising the Multimedia Access Device, and Multimedia Data Playing Method

(75) Inventors: Toon Jeow Foo, Singapore (SG); Steel Su, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 12/201,067

(22) Filed: Aug. 29, 2008

(30) Foreign Application Priority Data
Aug. 30, 2007 (TW) 96132227

(51) Int. Cl. G06F 15/16; H04L 9/18; G06F 21/00

(52) U.S. Cl. 709/231; 380/37; 726/27

(57) ABSTRACT

A multimedia access device, a multimedia playing system comprising the multimedia access device, and a multimedia data playing method are provided. The multimedia playing system comprises a portal web server, an interface, a multimedia access device, and a multimedia playing apparatus. The portal web server provides a file allocation table (FAT) comprising at least one file folder, each having at least one file. Each file is adapted to contain and correspond to at least one Internet data stream. The multimedia access device connects to the portal web server via the interface, selects one file from the FAT according to a selection signal, and converts the Internet data stream corresponding to this file into a USB data stream after receiving the Internet data stream via the interface.

This application claims priority to Taiwan Patent Application No. 096132227 filed on Aug. 30, 2004, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides a multimedia access device, a multimedia playing system comprising the multimedia access device, and a multimedia data playing method. In particular, the present invention provides a multimedia access device that allows a multimedia playing apparatus to play multimedia data from the Internet, a multimedia playing system comprising this multimedia access device, and a multimedia data playing method.

2. Descriptions of the Related Art

With the rapid development of science and technology, Internet information has steadily increased in volume. Various portal web servers that connect computers to the Internet allow for the user to browse information. These portal web servers, e.g., various portal websites, YouTube, Internet radio stations, podcastings or the like, provide mass multimedia data for users to watch or listen to through a computer.

However, despite the widespread use of computers, it is still impossible for a user to access computers in many places. That is, users have to connect the host computer to the Internet at specific locations, and download an Internet data stream to a register memory of the host computer via an Internet connection before playing the Internet data, which is a complex operational procedure. Furthermore, as limited by cost and target consumers, most peripheral devices used for multimedia playing purpose associated with a computer deliver poor quality, making the playing effect incomparable to that of a TV set, a projector dedicated to play movies or a sound box dedicated to play music.

It is also difficult to browse various files (especially video/audio streams or files) from the Internet without being restricted by occasions, locations, age of the user or computer knowledge of the user. This is because consumer electronic products (e.g., TV sets, camcorders or other multimedia playing apparatuses) that are found almost anywhere cannot provide such an Internet surfing function. One reason is because household multimedia playing apparatuses currently available depend on the remoter controller or buttons on the panel to perform the control and selection functions. However, surfing the Internet requires the input of a uniform resource locator (URL), which necessitates the use of a mouse and a keyboard to select and acknowledge the portal website. This makes it difficult for the household multimedia playing apparatuses and the webpage browsing interfaces to be compatible with each other, which is also the main reason why household appliance users are unlike computer users.

In summary, although more and more consumers demand to browse Internet multimedia data in a real time manner, most of the current household multimedia devices still make no provisions for Internet connection, and no portal web server has provided an interface compatible with a household remote controller yet. Therefore, it is still a great challenge in the art to enable a current multimedia playing apparatus to retrieve rich Internet multimedia data directly and to develop a multimedia data selection interface adapted for various multimedia playing apparatuses.

### SUMMARY OF THE INVENTION

One objective of this invention is to provide a multimedia access device adapted for playing Internet multimedia data. The multimedia access device comprises a signal input end, a processing unit and a signal output end. The signal input end is adapted for receiving a file allocation table (FAT) which comprises an Internet data stream via an interface. The processing circuit is adapted for receiving the FAT from the signal input end and converting the Internet data stream into a universal serial bus (USB) data stream according to a selection signal. The signal output end is adapted for transmitting the USB data stream to a multimedia playing apparatus for playing.

Another objective of this invention is to provide a multimedia playing system. The multimedia playing system comprises a portal web server, an interface, a multimedia access device as described above and a multimedia playing apparatus. The portal web server is adapted for providing a file allocation table (FAT), wherein the FAT comprises at least one file folder. The at least one file folder comprises at least one file, while the at least one file is adapted to contain and correspond to the Internet data stream. The interface is adapted for transmitting the FAT and the Internet data stream. The multimedia access device is adapted for connecting to the portal web server to receive the FAT via the interface and then to receive the Internet data stream via the interface according to a selection signal and for converting the Internet data stream into a universal serial bus (USB) data stream. The multimedia playing apparatus is adapted for receiving and playing the USB data stream.

Yet a further objective of this invention is to provide a multimedia data playing method, comprising the following steps: connecting to a portal web server, which provides a file allocation table (FAT), wherein the FAT comprises at least one file folder the file folder comprises at least one file, while the at least one file is adapted to contain and correspond to an Internet data stream; selecting at least one file from the FAT according to a selection signal; receiving the Internet data stream corresponding to the at least one file; converting the Internet data stream into a universal serial bus (USB) data stream; and transmitting the USB data stream to a multimedia playing apparatus for playing.

In summary, the multimedia playing system of this invention may transmit multimedia data and an FAT provided by the portal web server to the multimedia access device via an Internet connection of the interface. The Internet data stream is then converted by the multimedia access device into a USB data stream to be transmitted via a USB port connected between the multimedia access device and the multimedia playing apparatus. In this way, the multimedia playing apparatus may play the multimedia data in a real time manner. Moreover, the FAT further facilitates the selection of the multimedia data by the user.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a multimedia playing system according to a first embodiment of this invention;

FIG. 2 is a file allocation table (FAT) provided by a portal web server according to the first embodiment of this invention;

FIG. 3A schematically illustrates an appearance of a multimedia access device according to the first embodiment of this invention;

FIG. 3B is a block diagram of the multimedia access device according to the first embodiment of this invention;

FIG. 4 is a block diagram of the multimedia playing apparatus according to the first embodiment of this invention; and

FIG. 5 is a flow diagram of a second embodiment of this invention.

### DESCRIPTION OF THE PREFERRED EMBODIMENT

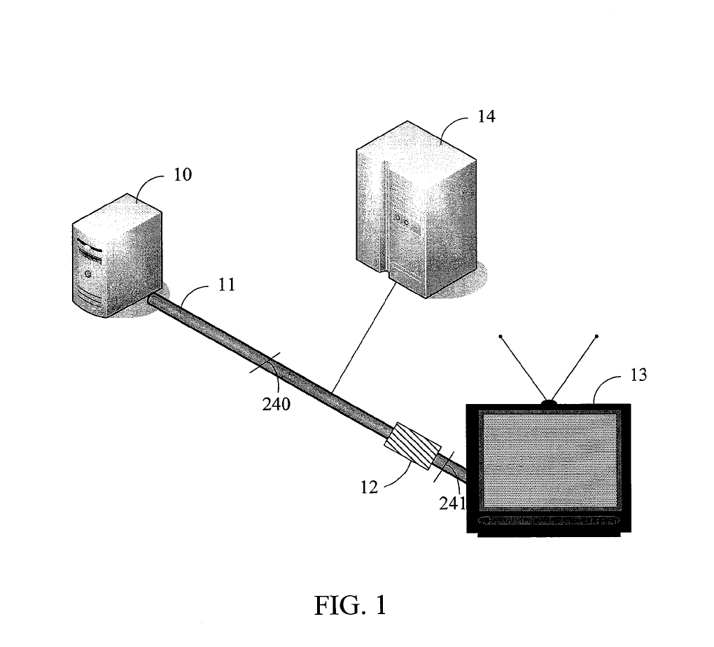

A first embodiment of this invention is a multimedia playing system 1, a schematic view of which is depicted in FIG. 1. The multimedia playing system 1 comprises a portal web server 10, an interface 11, a multimedia access device 12, a multimedia playing apparatus 13 and a router 14.

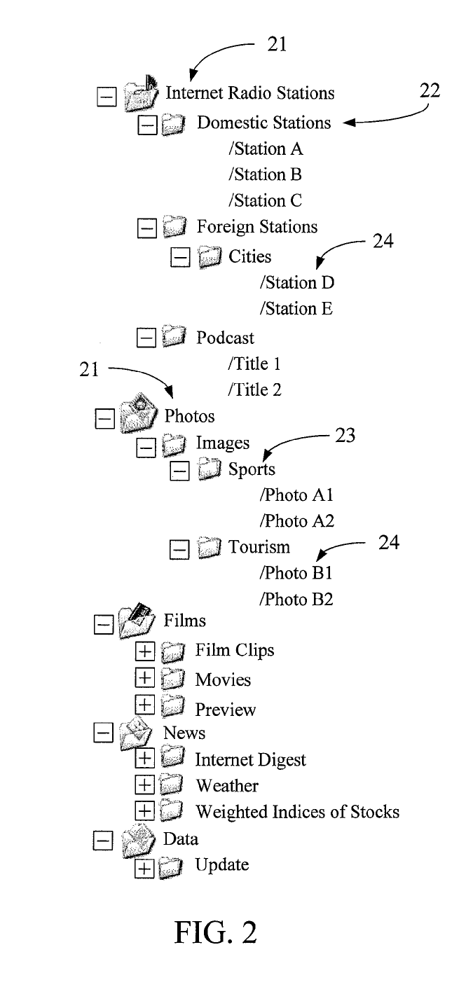

The portal web server 10 is configured to provide a file allocation table (FAT) 2. In reference to the FAT 2 shown in FIG. 2, the FAT 2 comprises a plurality of file folders 21, each of which may have a plurality of sub-file folders 22. The sub-file folders 22 may further comprise sub-file folders 23 of a lower level. Contained in a file folder of the last level is a plurality of files 24, each of which is adapted to contain a corresponding Internet data stream 240.

In practical applications, the portal web server 10 may incorporate all server websites providing multimedia files and hyperlink these websites to the file folders 21. The file folders 21 include file folders for Internet radio stations, photographs, movies, news and data as depicted in FIG. 2. The websites corresponding to the choices in a server webpage are allocated to these sub-file folders 22. If a webpage corresponding to the choice further includes a sub-choice, the website of this sub-choice is then allocated to a lower level sub-file folder 23. In the file folders of the last level, all files 24 provided by the portal web server 10 are listed with each of the files 24 establishing a hyperlink to a corresponding website. The portal web server 10 will collect information dynamically by itself to confirm the validity of hyperlinks on a real time basis. In case a webpage is updated or removed, the portal web server 10 will update the FAT 2 accordingly.

First, via the interface 11 and the multimedia access device 12, the portal web server 10 transmits the FAT 2 to the multimedia playing apparatus 13 for playing to inform the user of a directory of multimedia data contained in the FAT 2. The user may then transmit a selection signal by use of a controller (not shown) to select a multimedia data file 24 from the FAT 2 according to the selection signal. Subsequently, the portal web server 10 transmits an Internet data stream 240 corresponding to the file 24 to the multimedia access device 12 via the interface 11.

For example, the portal web server 10 may be provided by a portal website, a video/audio sharing website, an Internet TV station or an Internet radio station. The portal websites include Yahoo, Google and the like, the video/audio sharing websites include YouTube, KKBox and the like, and the Internet TV stations include Comcast, PPStream, Time Warner and the like.

As described previously, the interface 11 is configured to transmit the Internet data stream 240. The interface 11 of this invention may be implemented as a wired Internet interface and/or a wireless Internet interface. In this embodiment, the interface 11 includes a wired Internet interface which comprises an RJ 45 line or other types of Internet connection lines. Furthermore, the interface 11 further includes a wireless Internet interface, which is a wireless fidelity (WiFi) module 11′, as a spare Internet connection means. In other embodiments, the wired Internet interface may also be optic fibers. Alternatively, the interface 11 may be a wireless Internet interface, including a worldwide interoperability for microwave access (WiMAX) module.

The multimedia access device 12 is connected to the portal web server 10 via the interface 11. Prior to connection, the multimedia access device 12 first extracts an Internet Protocol (IP) address via a dynamic host configuration protocol (DHCP) server (not shown) built in a router 14 to receive Internet data streams 240 subsequently based on this IP address.

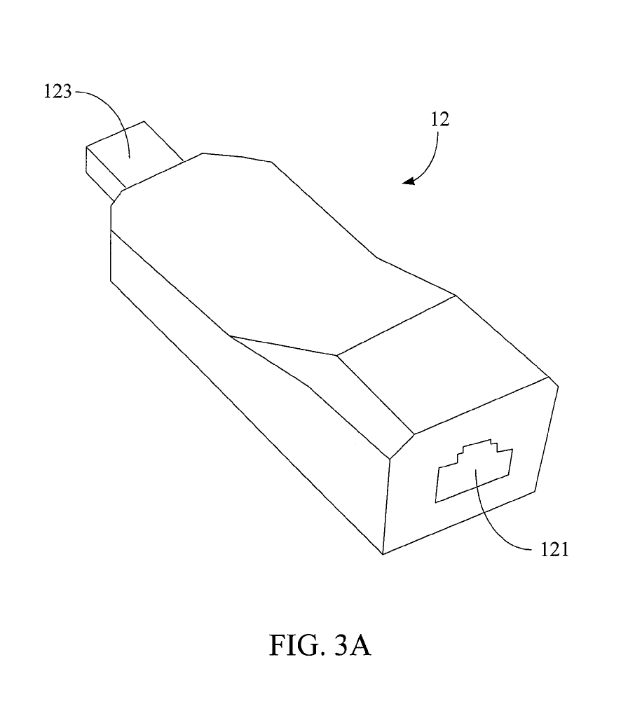

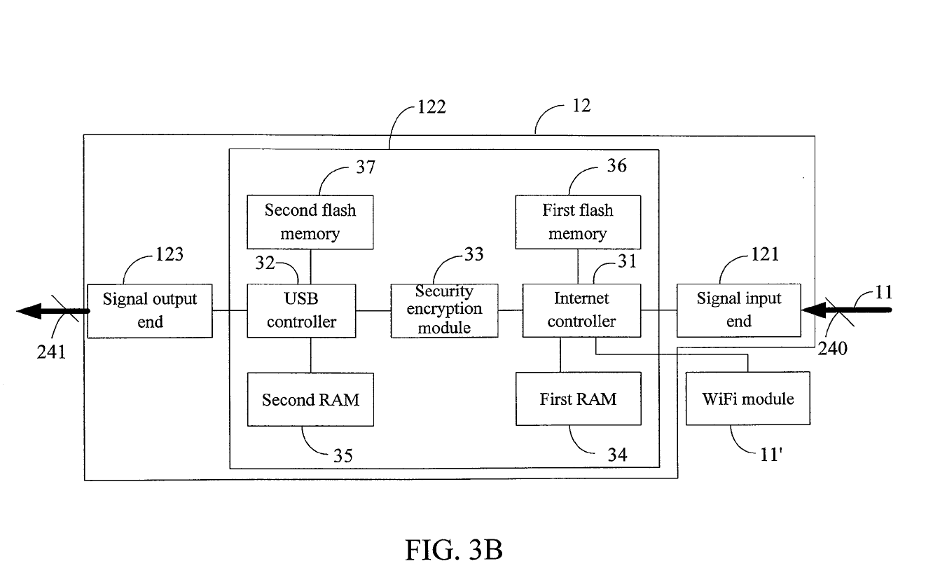

A schematic appearance and a block diagram of the multimedia access device 12 are depicted in FIG. 3A and FIG. 3B respectively. The multimedia access device 12 comprises a signal input end 121, a processing circuit 122 and a signal output end 123. The signal input end 121 of the multimedia access device 12 is adapted to receive an Internet data stream 240 from the portal web server 10 via the interface 11. The processing circuit 122 is configured to receive the Internet data stream 240 from the signal input end 121 and convert it into a universal serial bus (USB) data stream 241. The signal output end 123 is configured to transmit the USB data stream 241 to a multimedia playing apparatus 13 for playing.

The signal input end 121 comprises an Ethernet physical layer connection socket which, in this embodiment, is an RJ 45 port.

The processing circuit 122 comprises an Internet controller 31, a USB controller 32, a security encryption module (SEM) 33, a first random access memory (RAM) 34, a second RAM 35, a first flash memory 36 and a second flash memory 37. The Internet controller 31 is configured to ensure a normal connection to the Internet data stream 240. The USB controller 32 is configured to control the USB data stream to be transmitted to the multimedia playing apparatus 13. The SEM 33 is configured to encrypt at least one of the Internet data stream 240 and the USB data stream 241. In this embodiment, the SEM 33 is configured to encrypt the Internet data stream 240. The SEM 33 may comprise a digital rights management (DRM) or an advanced encryption standard (AES). The first RAM 34 is a static RAM (SRAM) for temporarily storing the Internet data stream 240. The second RAM 35 is a dynamic RAM (DRAM) for temporarily storing the USB data stream 241. Both the first flash memory 36 and the second flash memory 37 are configured to temporarily store a program code. Specifically, the first flash memory 36 is configured to store a first program code, while the second flash memory 37 is configured to store a second program code. In this embodiment, both the first flash memory 36 and the second flash memory 37 are a NOR flash memory.

The signal output end 123 comprises a USB physical interface which, in this embodiment, is a USB plug.

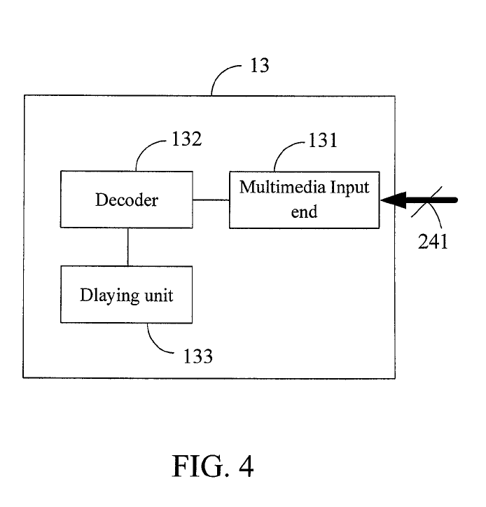

The multimedia playing apparatus 13 has a multimedia input end 131, a decoder 132 and a playing unit 133. FIG. 4 depicts a block diagram of the multimedia playing apparatus 13. The multimedia input end 131 is configured to receive the USB data stream 241, and has an interface adapted to cooperate with the signal output end 123 of the multimedia access device 12. In this embodiment, the multimedia input end 131 comprises a USB physical interface which is implemented as a USB socket for receiving the aforesaid USB plug. Then the decoder 132 within the multimedia playing apparatus 13 decodes the USB data stream 241 into a format adapted to be played by the playing unit 133. The decoder 132 may be an audio decoder or a video decoder. Now, the playing unit 133 may play the decoded USB data stream 241. In this embodiment, the multimedia playing apparatus 13 is a TV set. In other embodiments, the multimedia playing apparatus 13 may be an MP3 player, a portable media player (PMP), a TV set, a digital video disc (DVD) player, a digital video recorder (DVR), a personal digital assistant (PDA), a digital photo frame, a Micro HiFi system, an LCD TV, a digital camera, or a mobile phone. The Internet multimedia data may include text data, audio data, video data, still image data and animation data.

In this embodiment, apart from assisting the multimedia playing apparatus 13 in playing the Internet data stream 240, the multimedia access device 12 may further serve as a medium for downloading updating firmware. To be more specific, in this embodiment, a “data” file folder 21 in the FAT 2 provided by the portal web server 10 further contains an “update” sub-file folder 22, which contains a firmware updating file for updating the multimedia playing apparatus 13. Hence, the multimedia playing apparatus 13 can be connected to the Internet via the multimedia access device 12 to receive the Internet data stream 240 corresponding to the firmware updating files. Then the Internet data stream 240 is processed by the processing circuit 122 of the multimedia access device 12 into a corresponding USB data stream 241, which can be received by the multimedia playing apparatus 13 to update and upgrade the firmware. In addition to the playing apparatuses set forth above, the multimedia playing apparatus 13 of this embodiment may also be an information technology (IT) product such as a Network Attached Storage (NAS) or a printer server.

Additionally, the above operations are not merely limited to use for the firmware updating files of the multimedia playing apparatus 13. In other words, the “update” sub-file folder 22 contained in the “data” file folder 21 may contain firmware updating files for updating the multimedia access device 12. Accordingly, by connecting the multimedia access device 12 to the Internet to receive the Internet data stream 240 corresponding to the firmware updating files, firmware for the processing circuit 122 of the multimedia access device 12 may be updated and upgraded.

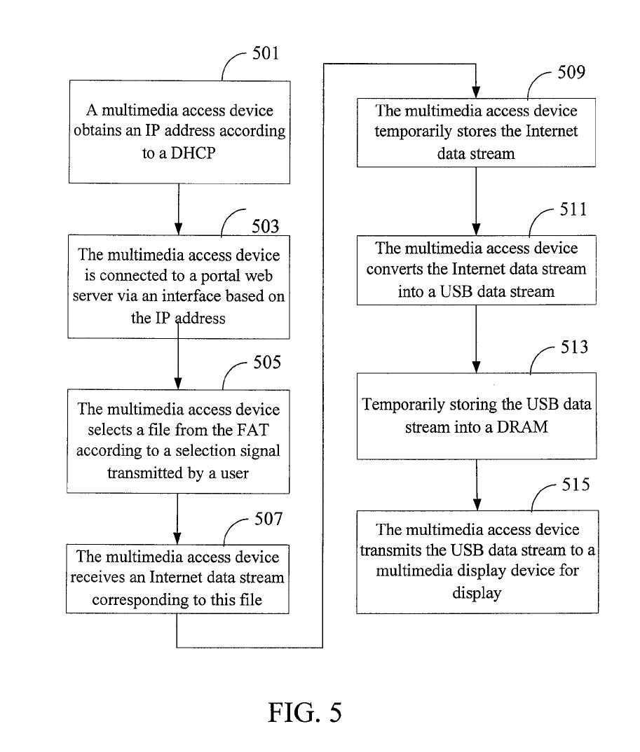

A second embodiment of this invention is a multimedia data playing method, a flow diagram of which is shown in FIG. 5. This method may be applied to the multimedia playing system 1 of the first embodiment. Likewise, the portal web server provides an FAT containing a plurality of file folders, each of which may include a plurality of sub-file folders. Each of the sub-file folders may further include a plurality of file folders of a lower level. In the file folder of the last level is at least one file, which is adapted to contain the corresponding Internet data stream. When the user receives information from the FAT, this method may commence.

This method comprises the following steps. In step 501, a multimedia access device obtains an IP address according to the dynamic host configuration protocol (DHCP). Then, in step 503, the multimedia access device is connected to a portal web server via an interface based on the IP address. In this embodiment, the interface is a wired Internet interface or a wireless Internet interface. With the wired Internet interface, the interface is an RJ45 line; and with the wireless Internet interface, the interface is a WiFi module.

Next in step 505, the multimedia access device selects a file from the FAT according to the selection signal transmitted by the user. In step 507, an Internet data stream corresponding to this file is received by the multimedia access device. Subsequently in step 509, the multimedia access device temporarily stores the Internet data stream, and this step is accomplished by a static RAM (SRAM) in the multimedia access device.

Then, in step 511, the Internet data stream is converted by the multimedia access device into a USB data stream. In this converting step, the encryption of the Internet data stream and the USB data stream may be further executed. This encrypting step is accomplished by a security encryption module (SEM), which comprises either a DRM or an AES.

Upon completion of the converting step, step 513 is executed to temporarily store the USB data stream into a DRAM. Finally in step 515, the USB data stream is transmitted by the multimedia access device to a multimedia playing apparatus for playing.

It should be emphasized that the steps of the second embodiment are not limited to the sequence set forth herein, and other steps may be added in each of the steps to further process the data. In addition to the steps described above, the second embodiment may further execute all the operations and functions described in the first embodiment. Those of ordinary skill in the art may readily appreciate how these operations and functions are executed in the second embodiment based on description of the first embodiment and thus, this will not be further described herein.

Besides what is described in the above embodiments, the multimedia access device of this invention may also serve as a common OTG (on the go) USB memory device. Accordingly, the user may further upload files stored in the multimedia playing apparatus to a portal web server via the multimedia access device. For example, the user may upload a photo stored in the memory card of a camera (i.e., a multimedia playing apparatus) to a portal web server where a web album resides via the multimedia access device.

For ease of understanding, the multimedia access device may also be viewed as a peripheral device of various multimedia playing apparatuses or computers. In use, by simply inserting the multimedia access device into a slot of a multimedia playing apparatus or a computer, the chip and other units within the multimedia access device can be supplied with power. Then, once a plug of an Internet connector is plugged into a socket of the multimedia access device, the multimedia playing apparatus will be connected to the Internet. Subsequently, through a selection made by the user, the multimedia playing apparatus may be connected to a particular portal web server to get an FAT. From this FAT, the user may select the desired multimedia data to watch or listen to.

Most of multimedia playing apparatuses developed at present are provided with a USB input/output port by using a multimedia access device of this invention. Such multimedia playing apparatuses can be extended in an easy way and can retrieve Internet data streams without the need of a host connected to the Internet. Because the FAT used in this invention is just the same as that used in a host computer, the user may be adapted to this operation interface in a shorter period and select a desired file without having to input a website address with a keyboard. With the small volume, the multimedia access device of this invention may be classified as a kind of USB dongle, which features a hot plugging capability, a plug and play (PnP) capability and a backward compatibility without the need of an extra power supply. In other words, the present invention provides the multimedia access device to emulate a USB Mass Storage Class such that the multimedia playing apparatus (e.g. a TV) with USB port would regard the multimedia access device as a mass storage device. Therefore, the user may select the respective “virtual” files that actually stream from the Internet portal via the interface with the multimedia playing system.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A multimedia access device adapted for playing Internet multimedia data, comprising:
a signal input end for receiving a file allocation table (FAT) which comprises an Internet data stream via an interface;
a processing circuit for receiving the FAT from the signal input end, and converting the Internet data stream into a universal serial bus (USB) data stream according to a selection signal; and
a signal output end for transmitting the USB data stream to a multimedia playing apparatus for playing.

2. The multimedia access device as claimed in claim 1, wherein the signal input end comprises an Ethernet physical layer connection socket.

3. The multimedia access device as claimed in claim 2, wherein the Ethernet physical layer connection socket is an RJ45 port.

4. The multimedia access device as claimed in claim 1, wherein the signal output end comprises a universal serial bus (USB) physical interface.

5. The multimedia access device as claimed in claim 1, wherein the interface is one of a wired Internet interface and a wireless Internet interface.

6. The multimedia access device as claimed in claim 5, wherein the interface is the wired Internet interface, and the wired Internet interface comprises an RJ45 line.

7. The multimedia access device as claimed in claim 5, wherein the interface is the wireless Internet interface, and the wireless Internet interface comprises a wireless fidelity (WiFi) module.

8. The multimedia access device as claimed in claim 1, wherein the processing circuit comprises an Internet controller and a USB controller.

9. The multimedia access device as claimed in claim 8, wherein the Internet controller is configured to ensure a normal connection of the Internet data stream.

10. The multimedia access device as claimed in claim 8, wherein the USB controller is configured to control the USB data stream to be transmitted to the multimedia playing apparatus.

11. The multimedia access device as claimed in claim 1, wherein the processing circuit further comprises a security encryption module (SEM) for encrypting at least one of the Internet data stream and the USB data stream.

12. The multimedia access device as claimed in claim 11, wherein the SEM comprises one of a digital rights management (DRM) and an advanced encryption standard (AES).

13. The multimedia access device as claimed in claim 1, wherein the processing circuit further comprises at least one random access memory (RAM) for temporarily storing the Internet data stream and the USB data stream.

14. The multimedia access device as claimed in claim 13, wherein the at least one RAM comprises a static RAM (SRAM) and a dynamic RAM (DRAM) for temporary storing the Internet data stream and the USB data stream respectively.

15. The multimedia access device as claimed in claim 8, wherein the processing circuit further comprises at least one flash memory for temporarily storing a program code.

16. The multimedia access device as claimed in claim 15, wherein the at least one flash memory comprises a first flash memory and a second flash memory for storing a first program code of the Internet controller and a second program code of the USB controller.

17. The multimedia access device as claimed in claim 1, wherein the Internet data stream is transmitted from a portal web server, and the portal web server transmits the Internet data stream to the multimedia access apparatus through the interface.

18. The multimedia access device as claimed in claim 17, wherein the portal web server provides the FAT, the FAT comprises at least one file folder, the at least one file folder comprises at least one file, and the at least one file is adapted to contain and correspond to the Internet data stream.

19. The multimedia access device as claimed in claim 1, wherein the multimedia access device extracts an Internet Protocol (IP) address with a Dynamic Host Configuration Protocol (DHCP) and receives the Internet data stream based on the IP.

20. The multimedia access device as claimed in claim 1, wherein the multimedia playing apparatus is an MP3 player, a portable media player (PMP), a television, a digital video disc (DVD) player, a digital video recorder (DVR), a personal digital assistant (PDA), a digital photo frame, a Micro HiFi system, a LCD TV, a digital camera, or a mobile phone.

21. The multimedia access device as claimed in claim 1, wherein the at least one file is a firmware updating file for updating the multimedia playing apparatus.

22. The multimedia access device as claimed in claim 1, wherein the at least one file is a firmware updating file for updating the multimedia access apparatus.

23. A multimedia playing system, comprising:
a portal web server for providing a file allocation table (FAT), wherein the FAT comprises at least one file folder, the at least one file folder comprises at least one file, and the at least one file is adapted to contain and correspond to the Internet data stream;
an interface for transmitting the FAT and the Internet data stream;
a multimedia access device as claimed in claim 1 for connecting to the portal web server to receive the FAT via the interface and then to receive the Internet data stream via the interface according to a selection signal and for converting the Internet data stream into a universal serial bus (USB) data stream; and
a multimedia playing apparatus for receiving and playing the USB data stream.

24. A multimedia data playing method, comprising:
connecting to a portal web server, which provides a file allocation table (FAT), wherein the FAT comprises at least one file folder, the at least one file folder comprises at least one file, and the at least one file is adapted to contain and correspond to an Internet data stream;
selecting at least one file from the FAT according to a selection signal;
receiving the Internet data stream corresponding to the at least one file;
converting the Internet data stream into a universal serial bus (USB) data stream; and
transmitting the USB data stream to a multimedia playing apparatus for playing.

25. The multimedia data playing method as claimed in claim 24, wherein the connecting step comprises a step of extracting an Internet Protocol (IP) address with a Dynamic Host Configuration Protocol (DHCP).

26. The multimedia data playing method as claimed in claim 25, wherein the connecting step is executed based on the IP.

27. The multimedia data playing method as claimed in claim 24, wherein the connecting step is executed by connecting through an interface.

28. The multimedia data playing method as claimed in claim 24, wherein the converting step further comprises encrypting one of the Internet data stream and the USB data stream.

29. The multimedia data playing method as claimed in claim 28, wherein the encrypting step is executed by a security encryption module (SEM).

30. The multimedia data playing method as claimed in claim 24, further comprising a step of temporarily storing the Internet data stream after executing the step of receiving the Internet data stream corresponding to the at least one file.

31. The multimedia data playing method as claimed in claim 30, wherein the temporarily storing step is executed by a static RAM (SRAM).

32. The multimedia data playing method as claimed in claim 24, further comprising a step of temporarily storing the USB data stream after executing the converting step.

33. The multimedia data playing method as claimed in claim 32, wherein the temporarily storing step is executed by a dynamic RAM (DRAM).
